(19) United States
(12) Patent Application Publication
(10) Pub. No.: US 2006/0126869 A1
(43) Pub. Date: Jun. 15, 2006

(54) Flat piezoelectric speaker actuator

(75) Inventor: Chuan-Chin Chiang, Ying Ko Town (TW)

Correspondence Address: Belltec Electroics Co., Ltd., P.O. Box No. 6-57, Junghe, Taipei, 235, TW

(73) Assignee: Belltec Electronics Co., Ltd.

(21) Appl. No.: 11/007,276

(22) Filed: Dec. 9, 2004

(51) Int. Cl. H04R 25/00

(52) U.S. Cl. 381/190

(57) ABSTRACT

A flat piezoelectric speaker actuator includes a flat piezoelectric speaker actuator, which is separated into a central section and wide wing sections, wherein the symmetrical wide wing sections respectively extend from sides of the central section. Total length of the actuator equals length of the wide wing sections plus length of the central section; total width equals width of the wide wing sections; wing length equals the length of each of the wide wing sections; and central width equals width of the central section.

When R1=R2=R3=1.618 and when total length=4.236 times the central width, superior values are achieved for degree of reduction in initial frequency and degree of flattening in a frequency response curve.

### BACKGROUND OF THE INVENTION

(a) Field of the Invention

The present invention provides an improved structure for a flat piezoelectric speaker actuator, and more particularly to the flat piezoelectric speaker actuator is separated into a central section and wide wing sections, wherein the symmetrical wide wing sections respectively extend from sides of the central section. Moreover, total length of the actuator equals length of the wide wing sections plus length of the central section; total width equals width of the wide wing sections; wing length equals the length of each of the wide wing sections; and central width equals width of the central section, that is

When Total length=R1, and R1>1;
Total width

When Total width=R2, and R2>1;
Wing length
Wing length=R3, and R3>1;
Central width

If R1=R2=R3=1.618, superior values are achieved for degree of reduction in initial frequency and degree of flattening in a frequency response curve, and when total length=4.236 times the central width, optimal values are achieved for degree of reduction in the initial frequency and degree of flattening in the frequency response curve.

(b) Description of the Prior Art

Referring to FIGS. 1 and 1A, which show a conventional flat piezoelectric speaker actuator A, wherein piezoelectric diaphragms Al are respectively configured on an upper and a lower side of a metal diaphragm A2, whereafter the metal diaphragm A2 is connected to a lead wire A5 by means of a metal lead wire A4, and thereon is connected to a sound device through a support A3 and a speaker paper cone. Referring to FIG. 1B, total length C1 necessarily equals twice length C2, and the support A3 is necessarily disposed at a position halfway along the total length C1. However, regarding relatively low audio frequencies, and referring to FIG. 1C, assuming the total length C1 equals 40 mm, and total thickness equals 0.3 mm, such a configuration is incapable of producing a good frequency response to a sound signal having a frequency lower than 400 Hz. Hence, the inventor of the present invention proposes to resolve and surmount existent technical difficulties to eliminate the aforementioned shortcomings.

### SUMMARY OF THE INVENTION

The present invention provides an improved structure for a flat piezoelectric speaker actuator. Referring to FIGS. 2 and 3, which show the flat piezoelectric speaker actuator of the present invention comprising a central section and wide wing sections. The flat piezoelectric speaker actuator is structured from piezoelectric diaphragms respectively configured on an upper and a lower side of a metal diaphragm, a support configured on one side of the central section, and a metal lead wire is utilized to connect to a lead wire. Wherein each of the piezoelectric diaphragms is configured from a metal electrode (positive) and a metal electrode (negative) separately configured on an upper and a lower side of a piezoelectric diaphragm respectively (see FIG. 4).

Furthermore, the present invention is characterized in that the symmetrical wide wing sections respectively extend from the central section. Referring to FIG. 5, total length equals length of the wide wing sections plus length of the central section B6; total width equals width of the wide wing sections; wing length equals length of each of the wide wing sections; and central width equals the width of the central section. Using the following formulas to calculate ratios, it can be known that:

When Total length=R1, and R1>1;
Total width

When Total width=R2, and R2>1;
Wing length
Wing length=R3, and R3>1;
Central width

If R1=R2=R3=1.618, superior values are achieved for degree of reduction in initial frequency and degree of flattening in a frequency response curve, and when total length=4.236 times the central width, optimal values are achieved for degree of reduction in the initial frequency-and degree of flattening in the frequency response curve.

Referring to FIG. 1C, assuming the total length equals 4 Omm, and total thickness equals 0.3 mm, such a configuration is incapable of producing a good frequency response to a sound signal having a frequency lower than 400 Hz. FIG. 9 shows an oscillogram for frequency against decibel value as tested with the present invention. As depicted in FIG. 9, resonant oscillation is produced at 250 Hz, thus showing that good frequency response can be achieved at lower audio frequencies. Moreover, the oscillogram of FIG. 9 shoes flattening of the frequency response curve at times of resonant oscillation, and further depicts closeness of spacing between each high and low points of the resonant oscillation response oscillogram. Upon a large fluctuation occurring in the audio frequency, rate of change in response is low, thereby maintaining a stable and excellent frequency response.

Referring to FIG. 1B, when the total length equals the total length, and the central width equals the total width, thereby configuring the actuator of the present invention with same length and width as that of a conventional flat piezoelectric speaker actuator, with such a configuration the present invention is able to achieve superior effectiveness in reducing the initial frequency and flattening of the frequency response curve by means of structural characteristics of the wide wing sections when compared to performance of the conventional flat piezoelectric speaker actuator, as depicted in FIG. 9 and FIG. 1C respectively. Furthermore, configuring the conventional flat piezoelectric speaker actuator with corresponding proportions of the present invention, and using the aforementioned formulas to calculate ratio of changed portions, it is found that there is no change in functionality achieved.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an elevational view of a conventional flat piezoelectric speaker actuator.

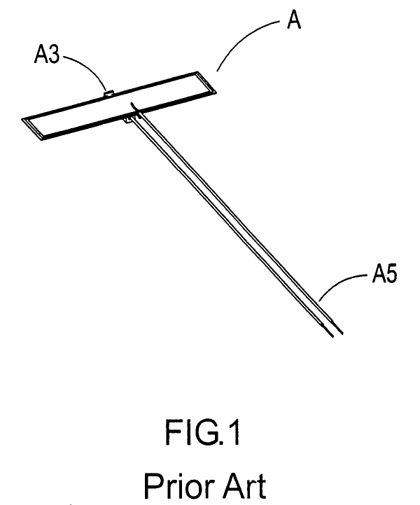

FIG. 1A shows an exploded elevational view of the conventional flat piezoelectric speaker actuator.

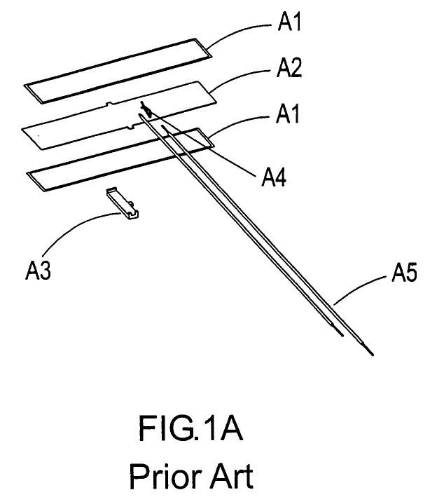

FIG. 1B shows a plane view of the conventional flat piezoelectric speaker actuator.

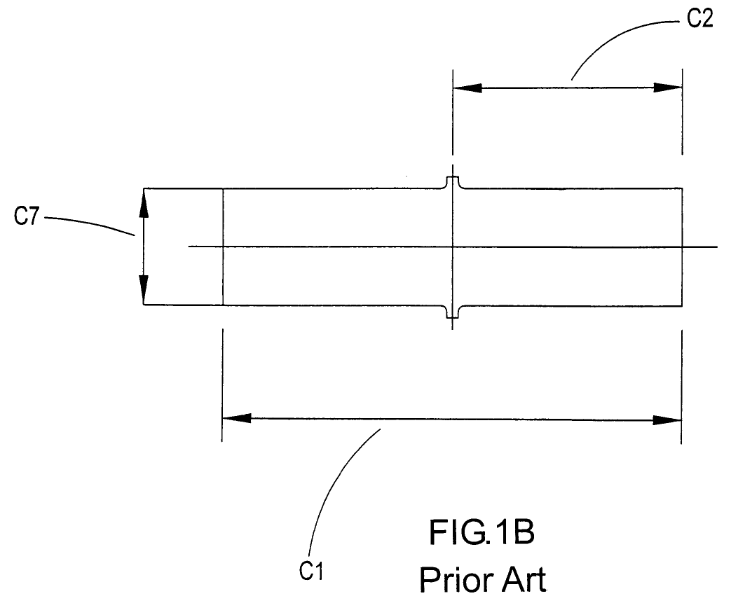

FIG. 1C shows a test oscillogram of the conventional flat piezoelectric speaker actuator.

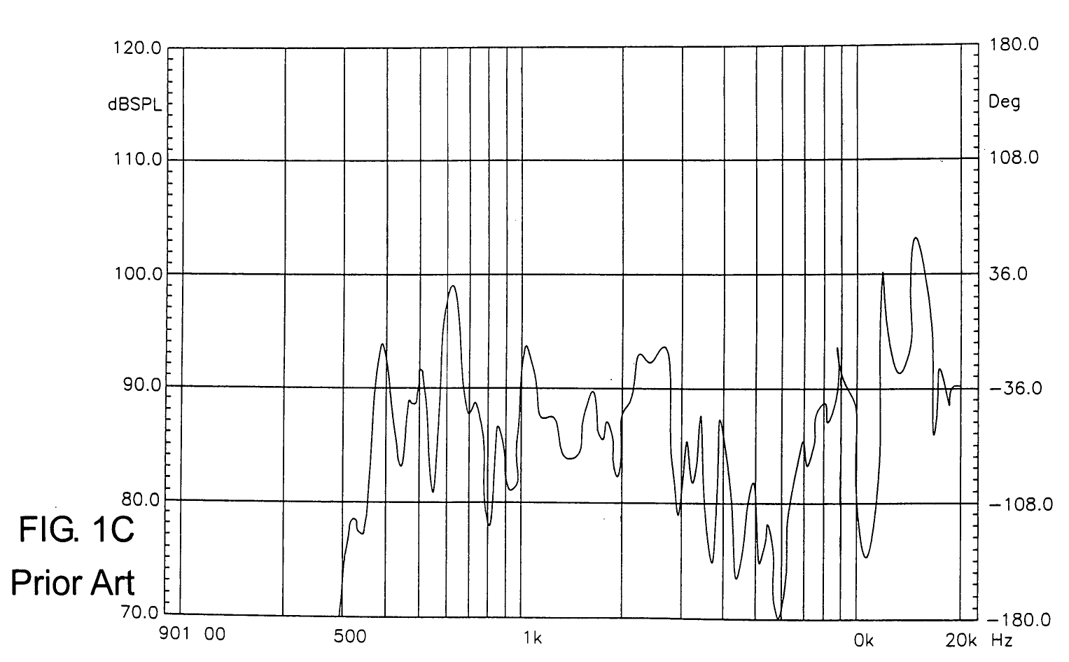

FIG. 2 shows an elevational view according to the present invention.

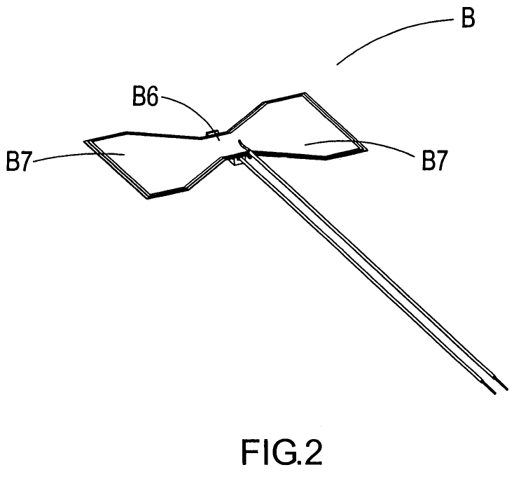

FIG. 3 shows an exploded elevational view according to the present invention.

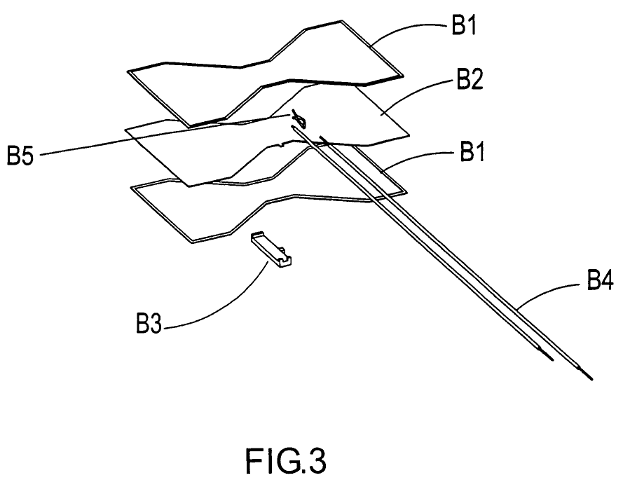

FIG. 4 shows a cross-sectional view according to the present invention.

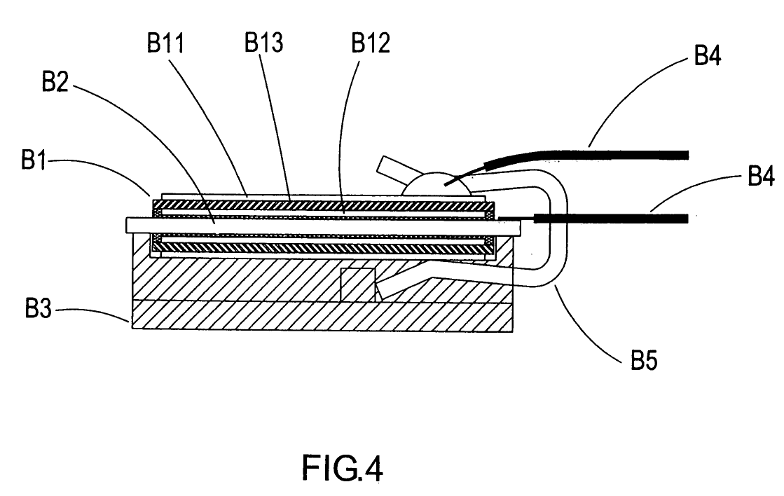

FIG. 5 shows a plane view according to the present invention.

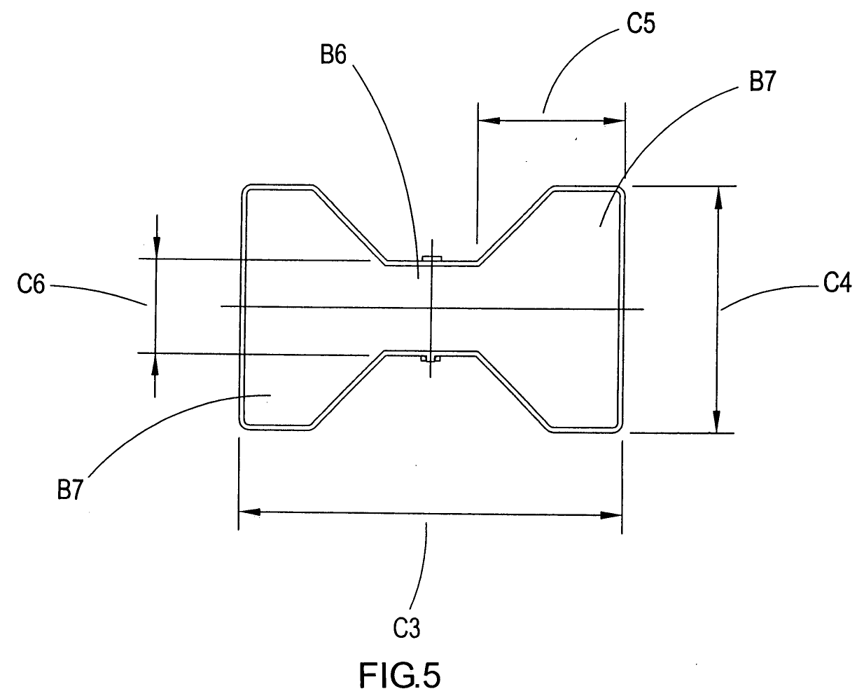

FIG. 6 shows an elevational view of an embodiment according to the present invention.

FIG. 6A shows another view of the embodiment according to the present invention.

FIG. 7 shows an elevational view of another embodiment according to the present invention.

FIG. 7A shows another view of another embodiment according to the present invention.

FIG. 8 shows an elevational view of yet another embodiment according to the present invention.

FIG. 9 shows a test oscillogram according to the present invention.

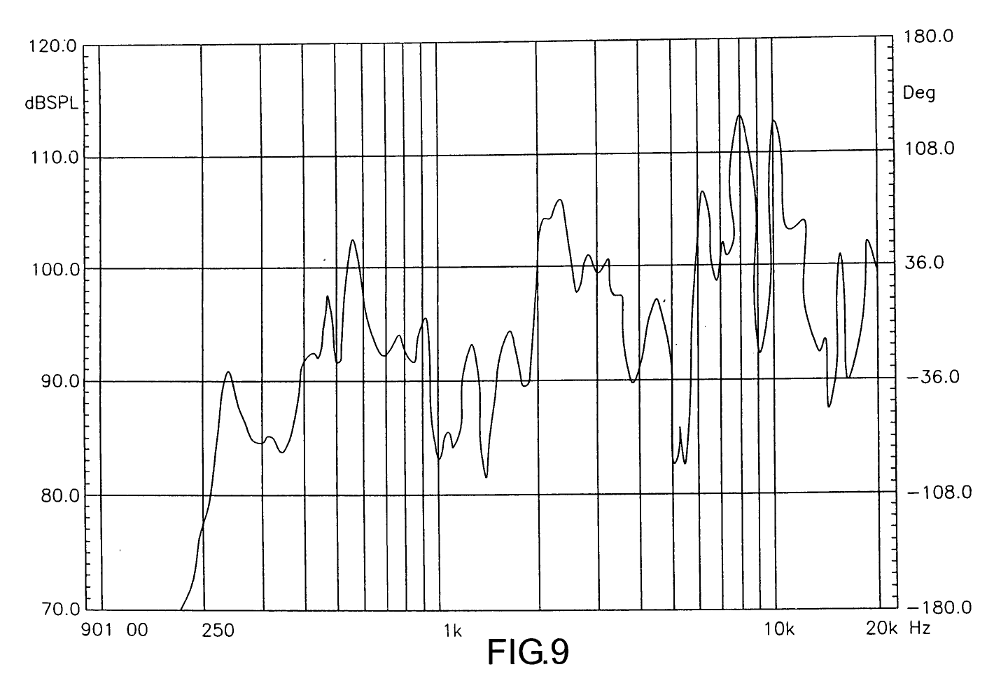

### DETAILED DESCRIPTION OF THE PREFERRED EMBODIMENTS

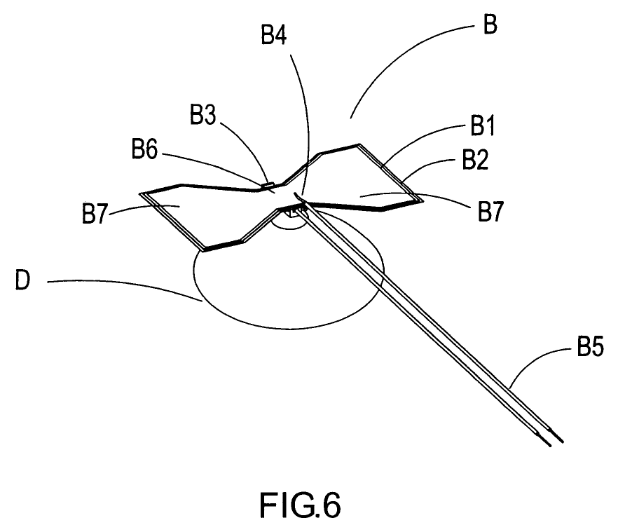

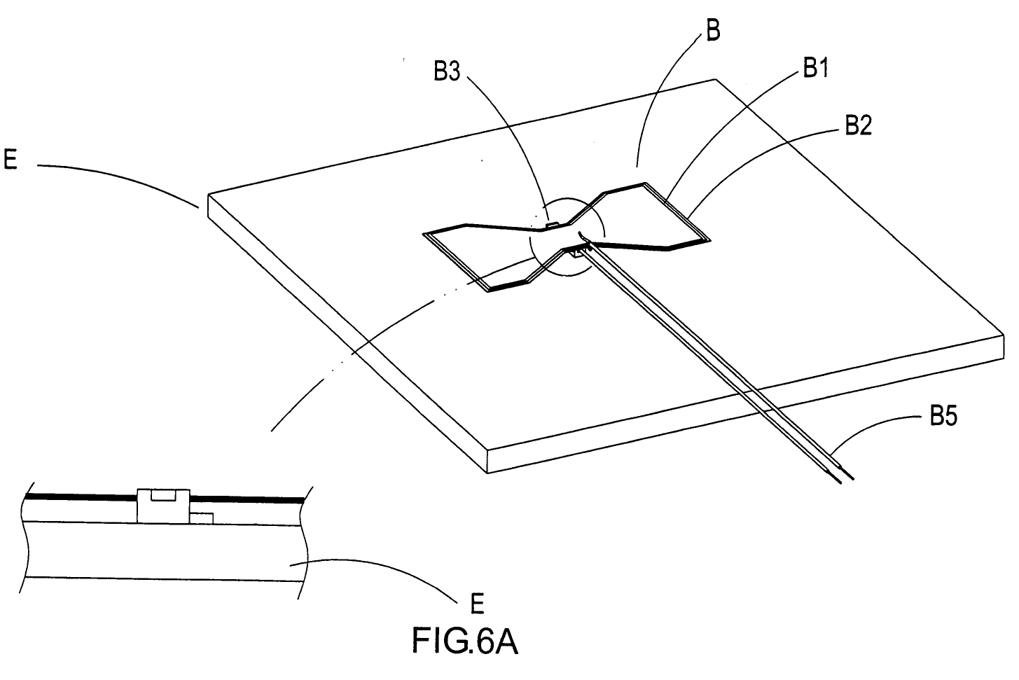

An embodiment of the present invention provides an improved structure for a flat piezoelectric speaker actuator. Referring to FIGS. 6 and 6A, upon a signal being transmitted into the flat piezoelectric speaker actuator B. piezoelectric diaphragms B1 and a metallic diaphragm B2 are thereupon actuated to produce a resonant wave, whereafter the wave is transmitted to a paper cone D or a flat board E through a support B3, and sound is produced therefrom. The flat board E can be configured as a wooden board, a metal plate, an acrylic board, a rubber board, a paper board, and so on.

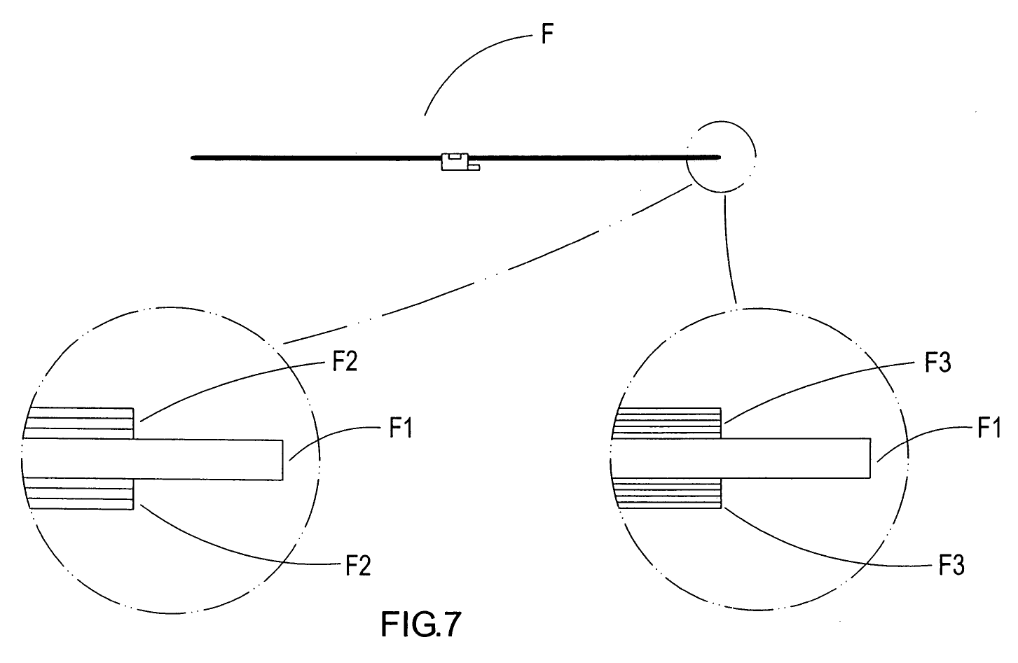

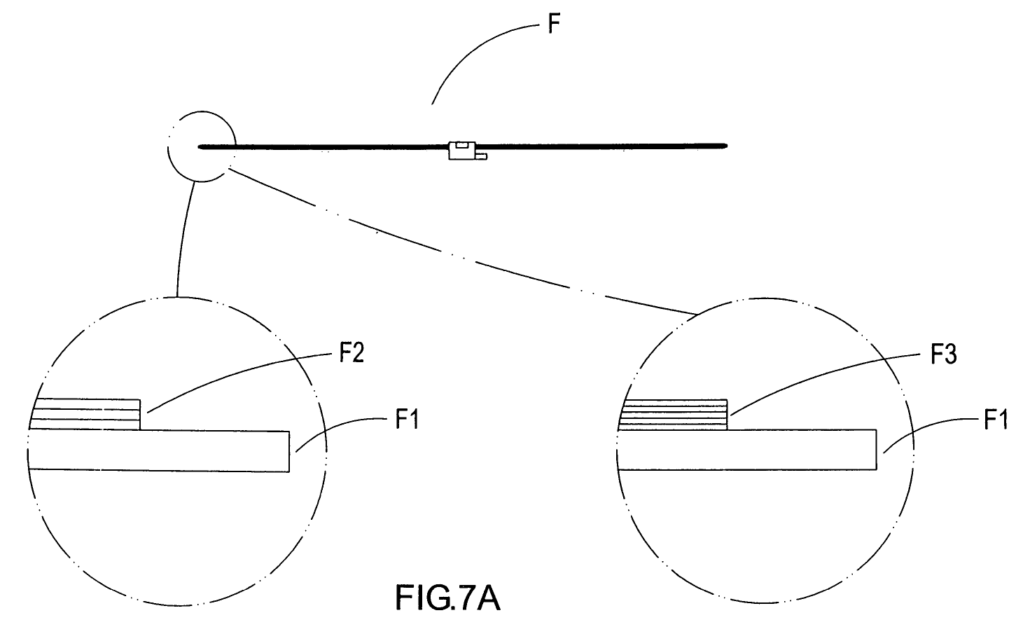

Referring to FIGS. 7 and 7A, piezoelectric diaphragms F2 configured on a metal piezoelectric diaphragm F1 of the flat piezoelectric speaker actuator F can be configured as a tri-layered, five-layered or multi-layered piezoelectric diaphragm, the multi-layered piezoelectric diaphragms F2 so configured being equally provided with same functionality. Furthermore, the piezoelectric diaphragm F2 on the metal piezoelectric diaphragm F1 can be further configured on a single side while still having the same functionality.

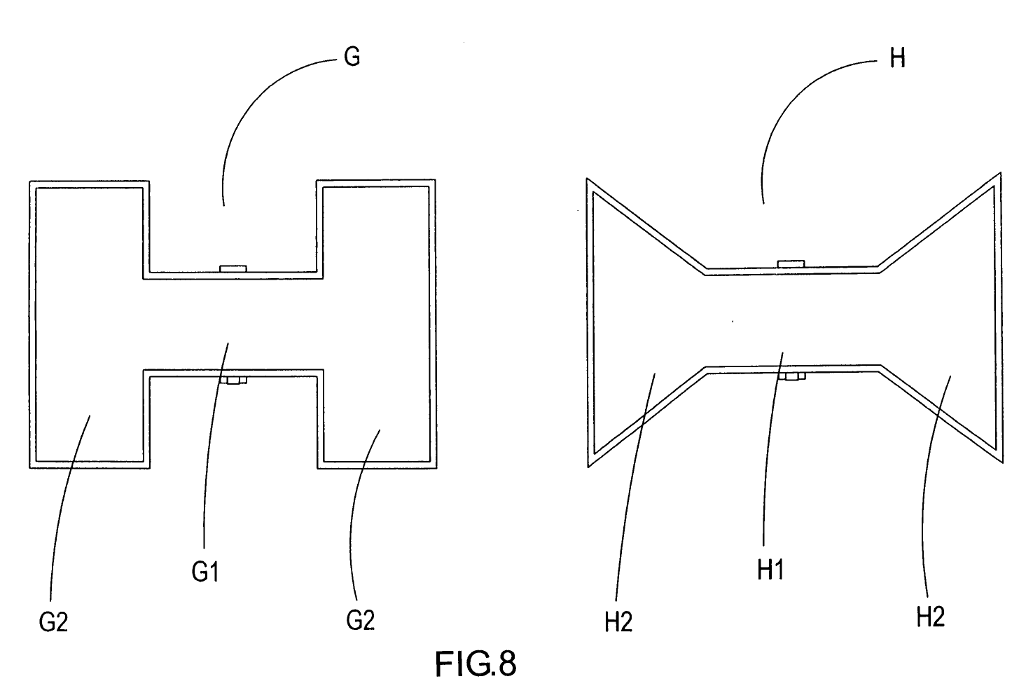

Referring to FIG. 8, which shows flat piezoelectric speaker actuators G, H of the present invention, wherein scale of wide wing sections G2, H2 is larger than scale of central sections GI, HI respectively, moreover, the respective wide wing sections G2, H2 can be further respectively configured on sides of the central sections G2, H2 respectively in a plurality of symmetrical shapes including ladder-shaped, rectangular-shaped, circular-shaped, triangular-shaped, and so on, while equally achieving functionality to reduce initial frequency and flatten a frequency response curve.

In order to better explicitly disclose advancement and practicability of the present invention, a comparison with conventional art is described hereinafter:

Shortcomings of a conventional flat piezoelectric speaker actuator:

1. Poor response at low frequency.

2. Poor sound effect at low sound frequency.

3. High distortion at low frequency, and small sound frequency range.

Advantages of the present invention:

1. Enhanced response at low frequency.

2. Excellent sound effect at low sound frequency.

3. Flattening of the complete frequency response curve, producing sound with extremely low distortion.

4. Higher tolerance in audio frequency range.

5. Provided with advancement and practicability.

6. Enhances commercial competitiveness.

In conclusion, the present invention in surmounting structural shortcomings of prior art has assuredly achieved effectiveness of anticipated advancement, and moreover, is easily understood by persons unfamiliar with related art. Furthermore, contents of the present invention have not been publicly disclosed prior to this application, and advancement and practicability of the present invention clearly comply with essential elements as required for a new patent application. Accordingly, a new patent application is proposed herein.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A flat piezoelectric speaker actuator comprising piezoelectric diaphragms, a metal diaphragm, a support, a metal lead wire and a lead wire, and the flat piezoelectric speaker actuator is separated into a central section and wide wing sections;
wherein the piezoelectric diaphragms are configured from a metal electrode (positive) and a metal electrode (negative) separately configured on an upper and a lower side of a piezoelectric diaphragm respectively;
and characterized in that: piezoelectric diaphragms are respectively configured on an upper and a lower side of a metal diaphragm, a support is configured on one side of the central section, and a metal lead wire is utilized to connect to a lead wire;
the symmetrical wide wing sections respectively extend from sides of the central section, total length equals length of the wide wing sections plus length of the central section, total width equals width of the wide wing sections, wing length equals length of the wide wing sections, and central width equals the width of the central section, and
When Total length=R1, and R1>1;
Total width
When Total width=R2, and R2>1;
Wing length
Wing length=R3, and R3>1;
Central width
if R1=R2=R3=1.618, superior values are achieved for degree of reduction in initial frequency and degree of flattening in a frequency response curve, and when the total length=4.236 times the central width, optimal values are achieved for degree of reduction in the initial frequency and degree of flattening in the frequency response curve.

2. Method for reducing frequency of the flat piezoelectric speaker actuator according to claim 1, wherein scale of the wide wing sections is larger than scale of the central sections, moreover, the respective wide wing sections can be further respectively configured on the sides of the central section in a plurality of symmetrical shapes including ladder-shaped, rectangular-shaped, circular-shaped, triangular-shaped, and so on, while equally achieving high and low frequency response.

3. Method for reducing frequency of the flat piezoelectric speaker actuator according to claim 1, wherein the piezoelectric diaphragm can be further configured as a piezoelectric diaphragm having configuration including single-side single layered, single-side tri-layered, single-side five-layered, double-sided tri-layered, double-sided five-layered up to single-side multi-layered or double-sided multi-layered.

4. Method for reducing frequency of the flat piezoelectric speaker actuator according to claim 2, wherein the piezoelectric diaphragm can be further configured as a piezoelectric diaphragm having configuration including single-side single layered, single-side tri-layered, single-side five-layered, double-sided tri-layered, double-sided five-layered up to single-side multi-layered or double-sided multi-layered.

5. Method for reducing frequency of the flat piezoelectric speaker actuator according to claim 1, wherein a flat board connected to a support can be further configured as a wooden board, a metal plate, an acrylic board, a rubber board, a paper board, and so on.

6. Method for reducing frequency of the flat piezoelectric speaker actuator according to claim 2, wherein a flat board connected to a support can be further configured as a wooden board, a metal plate, an acrylic board, a rubber board, a paper board, and so on.

7. Method for reducing frequency of the flat piezoelectric speaker actuator according to claim 3, wherein a flat board connected to a support can be further configured as a wooden board, a metal plate, an acrylic board, a rubber board, a paper board, and so on.
